(19) United States
(12) Patent Application Publication
(10) Pub. No.: US 2022/0136626 A1
(43) Pub. Date: May 5, 2022

(54) GASKETED PIPE JOINT FORMED IN PLACE AND METHOD OF MAKING SAME

(71) Applicant: IPS Corporation, Compton, CA (US)

(72) Inventors: Andreas Schneider, Fullerton, CA (US); Xiaoyi Xie, Diamond Bar, CA (US)

(21) Appl. No.: 17/428,312

(22) PCT Filed: Feb. 5, 2020
(86) PCT No.: PCT/US20/16692

§ 371 Date: Aug. 4, 2021

Related U.S. Application Data
(60) Provisional application No. 62/802,429, filed on Feb. 7, 2019.

(51) Int. Cl. F16L 13/11; F16L 13/10

(52) U.S. Cl. CPC F16L 13/116; F16L 13/103

(57) ABSTRACT

Described herein are gasketed pipe joints. In some embodiments, a joined pipe assembly is provided that includes: a first pipe having a first end portion with a first outer diameter and a first inner diameter; a second pipe having a second end portion with a second inner diameter and a second outer diameter, wherein the second end portion nests within the first end portion; wherein the first end portion includes a circumferential recess, and wherein an inner surface of the recess is located radially outward of the first inner diameter to form a pocket; and an adhesive gasket positioned in the pocket and adhered to the inner surface of the recess and the second outer diameter.

### STATEMENT OF PRIORITY

This application claims priority from and the benefit of U.S. Provisional Application Ser. No. 62/802,429, filed Feb. 7, 2019, the disclosure of which is hereby incorporated herein in its entirety.

### FIELD OF THE INVENTION

The present invention is directed generally to a pipe joint, and is directed more particularly to a gasketed pipe joint.

### BACKGROUND

Polyvinylchloride (PVC) pipe is widely used in municipal water distribution and is typically laid below ground, where the weight of the soil on top of the pipe holds the pipe and any gasketed joints between pipe sections in place. Gasketed joints typically entail one pipe with an enlarged “bell” section at one end that fits over a “spigot” end of the joined pipe. The gasket fits within a “bulge” in the bell section and provides a seal between the bell section and the spigot. Specifications for pipe joints using flexible elastomeric seals are set forth in ASTM D 3139 and AWWA C900-16 standards.

This arrangement can be understood by reference to FIG. 1, which illustrates a cross-section of a first pipe 10 attached to a second pipe 20. The first pipe 10 has a main section 12 that merges with a bell section 14 of slightly larger outer and inner diameter than the main section 12. A ridge (or bulge) 16 extends radially outwardly from an intermediate location of the bell section 14. One end 22 of the second pipe 20 nests within the bell section 14. The outer surface of the second pipe 20 and the recessed inner surface of the bell section 14 form a circumferential recess 17 that defines a circumferential pocket 18. A gasket 24 fits within the pocket 18 to form a seal between the first and second pipes 10, 20.

In certain instances, couplings (also referred to as fittings) are used to connect pipes. These couplings are essentially two gasketed bells that are connected and can be prepared by thermoforming pipe to obtain the desired bulges, by selectively shaving off the inside wall of thicker wall pipe to create the space for the gasket, or by injection molding the coupling. Example couplings include, but are not limited to, those described in “FITTINGS FOR PVC PRESSURE PIPELINES” published by the Uni-Bell PVC Pipe Association of Dallas, Tex. (https://www.uni-bell.org/portals/0/ResourceFile/fittings-for-pvc-pressure-pipelines.pdf). All descriptions and references to joining pipes herein may include the use of the couplings such as, e.g., those described herein.

In certain instances in pipe layouts, such as those including turns and/or T's or those routed in roadway overpasses, it is required that the gasketed pipe joint be mechanically restrained to avoid “pushout” (i.e., separation) of the joined pipes. Such mechanical restraints can either be installed on the outside of the pipe or the inside.

Mechanical restraints on the outside of the pipe are typically manufactured from steel and are connected using nuts and bolts, which can be labor-intensive and time-consuming. Further, the steel of the restraint can corrode if it is exposed to water.

A more recent development is the use of internal locking systems, such as the Eagle Loc 900 system (available from JM Eagle, Los Angeles, Calif.). However, this approach has the disadvantage that it only restrains the pipe in tension; if the connected pipes are compressed, the spigot of one pipe can exert to strong forces onto the bell section of the other pipe, leading to catastrophic cracking of the pipe with the bell section.

In view of the foregoing, alternative methods of joining gasketed pipe may be desirable.

### SUMMARY

A first aspect of the present invention is directed to a joined pipe assembly. The joined pipe assembly may include a first pipe having a first end portion with a first outer diameter and a first inner diameter, a second pipe having a second end portion with a second inner diameter and a second outer diameter, wherein the second end portion nests within the first end portion, wherein the first end portion includes a circumferential recess, and wherein an inner surface of the recess is located radially outward of the first inner diameter to form a pocket, and an adhesive gasket positioned in the pocket and adhered to the inner surface of the recess and the second outer diameter.

An additional aspect of the present invention is directed to a method of joining two pipes. The method may include the steps of: providing a first pipe, the first pipe having a first end portion with a first outer diameter and a first inner diameter, wherein the first end portion includes a circumferential recess, and wherein an inner surface of the recess is located radially outward of the first inner diameter to form a pocket; providing a second pipe, the second pipe having a second end portion with a second inner diameter and a second outer diameter; inserting the second end portion within the first end portion; and introducing an adhesive gasket into the pocket, the adhesive gasket adhering to the inner surface of the recess and the second outer diameter to join the first and second pipes.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a side section view of a prior art gasketed pipe joint.

FIG. 2 is a flow chart illustrating a method for forming a gasketed pipe joint according to embodiments of the invention.

FIG. 3 is a side section view of first and second pipes to be joined according to the method described in FIG. 2 prior to the introduction of uncured adhesive to the pocket defined by the pipes.

FIG. 4 is a schematic side section view of the first and second pipes of FIG. 3 illustrating the introduction of uncured adhesive into the pocket.

FIG. 5 is a side section view of the gasketed pipe joint of FIGS. 3 and 4 after curing of the adhesive gasket.

FIG. 6 is a side view showing a coupling with two separate pipe ends inserted into the coupling.

FIG. 7 is a side section view of a coupling with two separate pipe ends inserted therein according to alternative embodiments of the invention.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. All published documents including U.S. patents and patent applications mentioned anywhere in this application are hereby expressly incorporated by reference in their entirety.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The term “about”, as used herein with respect to a value or number, means that the value or number can vary by ±20%, ±10%, ±5%, ±1%, ±0.5%, or even ±0.1%.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “d est,” may be used to specify a particular item from a more general recitation.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

The shortcomings of the gasketed PVC pipe joints discussed above can be addressed by joining methods and configurations described below. Pipe joint(s) as used herein include, but are not limited to, pipes and/or couplings as described herein. The method (summarized in FIG. 2) comprises the steps of: (a) providing a first pipe, the first pipe having a first end portion with a first outer diameter and a first inner diameter, wherein the first end portion includes a circumferential recess, which optionally extends radially outwardly from the first outer diameter and forms a pocket on the inner surface (Box 202); (b) providing a second pipe, the second pipe having a second end portion with a second inner diameter and a second outer diameter (Box 204); (c) inserting the second end portion within the first end portion (Box 206); and (d) introducing an adhesive gasket into the pocket, the adhesive gasket adhering to the inner surface of the recess and the second outer diameter to join the first and second pipes (Box 208).

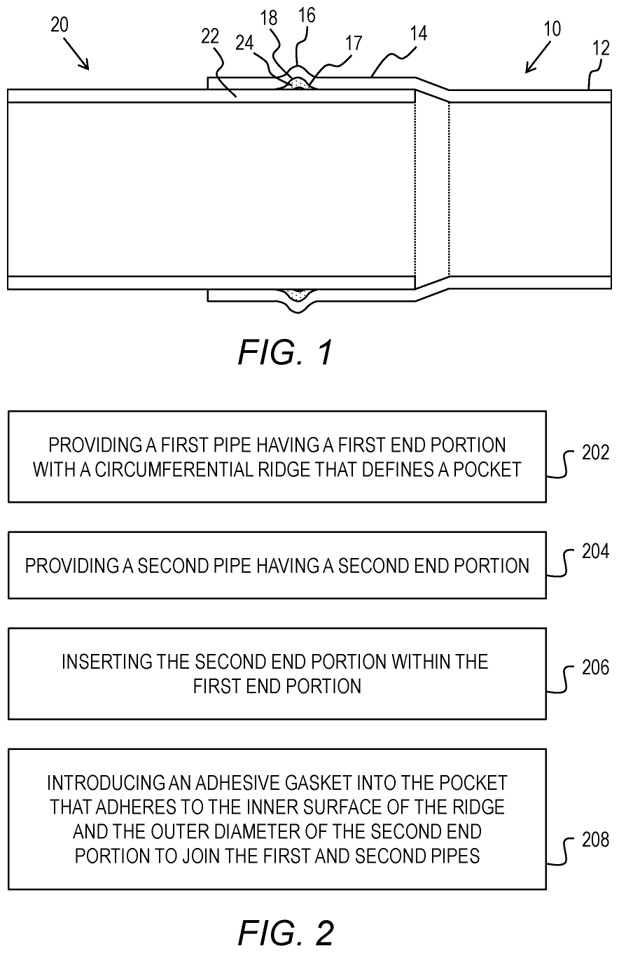

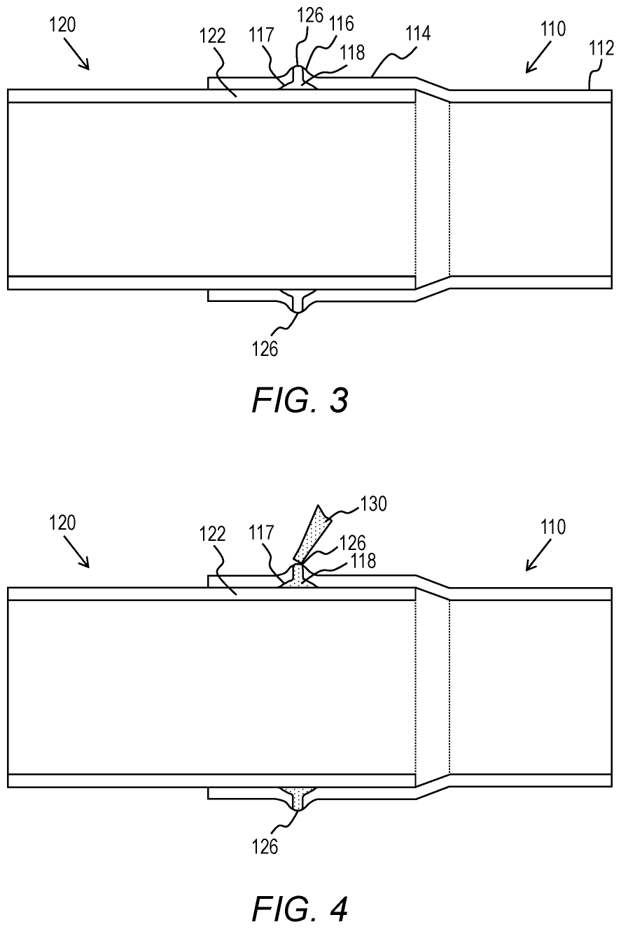

This method can be understood in more detail with reference to FIGS. 3-5. FIG. 3 is a cross-section of a first pipe 110 and a second pipe 120 similar to those shown above in FIG. 1. The first pipe 110 has a main section 112 that merges with an end portion in the form of a bell section 114. The thickness of the first pipe 110 is substantially constant, such that the bell section 114 has inner and outer diameters that are greater than those of the main section 112. The bell section 114 includes a ridge 116 that extends radially outwardly, such that the outer surface of the ridge 116 is radially outward of the outer diameter of the bell section 114, and the inner surface of the ridge 116 is radially outward of the inner diameter of the bell section 114, thereby forming a recess 117 in the inner surface of the bell section 114.

The second pipe 120 has outer and inner diameters that are substantially the same as those of the main section 112 of the first pipe 110. One end portion 122 of the second pipe 120 nests within the bell section 114. The outer surface of the second pipe 120 and the recess 117 in the inner surface of the bell section 114 form an annular pocket 118.

The first pipe 110 differs from the first pipe 10 in that the ridge 116 includes a plurality of ports 126 that provide access to the pocket 118 from outside of the first pipe 110. In the illustrated embodiment, there are two generally circumferentially equidistant ports 126 (each of which are visible in FIG. 2), although any number and/or arrangement in ports 126 may be employed.

The first pipe 110 and the second pipe 120 can be of any suitable size. Typically PVC pipe employed with gasketed joints can range in nominal diameter from about 4 to 60 inches. In some embodiments, the first pipe 110 and/or the second pipe may have a diameter of about 4, 6, 8, 10, 12, 15, 18, 21, 24, 27, 30, 32, 34, 36, 38, 40, 42, 44, 46, 48, 50, 52, 54, 56, 58, or 60 inches. Wall thickness of the pipes 110, 120 can range from about 0.1 to about 1 inch, such as, e.g., about 0.12, 0.18, 0.24, 0.3, 0.36, 0.43, 0.5, 0.6, 0.65, or 0.745 inch. The inner and outer diameters of the bell section 114 are typically greater than those of the main section 112 by an amount that is generally equal to, but slightly larger than, the wall thickness of the pipe 110, which can create a gap of up to about 1 cm therebetween. This gap can facilitate the entry of the end portion 122 of the second pipe 120 into the bell section 114. The ridge 116 typically extends radially outwardly about 0.3 and 1.5 inches from the remainder of the bell section 114.

The pipes 110, 120 illustrated herein are contemplated as being PVC pipes, but those of skill in this art will appreciate that pipes formed of other materials may benefit from the techniques and/or adhesives described herein. In some embodiments, the first pipe 110 and/or second pipe 120 is a pressure pipe (e.g., a PVC pressure pipe such as, e.g., C900 PVC pipe) and/or a non-pressure pipe (e.g., a PVC non-pressure pipe such as, e.g., one used for sewer (e.g., gravity sewer pipe)).

Referring now to FIG. 4, it can be seen that an adhesive gasket 130 may be introduced into the pocket 118 through one or more of the ports 126. The adhesive comprising the adhesive gasket 130 is introduced (e.g., added, injected, flowed, etc.) in liquid/paste form (i.e., it is uncured) into a port 126 and allowed to fill the pocket 118. Once the pocket 118 is filled with uncured adhesive, the adhesive is permitted to cure within the pocket 118 until it hardens into the annular adhesive gasket 130. The adhesive gasket 130 both adheres to (and therefore joins) the first pipe 110 and the second pipe 120 and provides the seal needed between the first pipe 110 and the second pipe 120. Because the first and second pipes 110, 120 are joined, they may not require mechanical restraints of the variety discussed above. In some embodiments, a method of the present invention may include removing any solid material (e.g., a rubber gasket) present in the pocket 118 prior to introducing the adhesive into the pocket 118.

In some embodiments, the uncured adhesive is introduced into one port 126 until it flows from another port 126 (often a port directly opposite of the port into which the adhesive is introduced) to indicate that the pocket 118 has been filled. For example, and as shown in FIG. 5, uncured adhesive injected into the port 126-1 at the top of FIG. 3 is allowed to flow around the pocket 118 until it flows out of the port 126-2 at the bottom of FIG. 5.

The uncured adhesive may fill the pocket 118 and/or ports 126 completely (i.e., so there are no voids in the pocket 118 and/or ports 126) or partially (i.e., some voids are present). In some embodiments, the uncured adhesive is introduced into one port 126 and the uncured adhesive fills about 80%, 81%, 82%, 83%, 84%, 85%, 86%, 87%, 88%, 89%, 90%, 91%, 92%, 93%, 94%, 95%, 96%, 97%, 98%, 99%, or 100% of the volume of the pocket 118 and/or ports 126. The adhesive gasket 130 may completely (i.e., no voids are present) or partially (i.e., some voids are present) fill the volume of the pocket 118 and/or ports 126. In some embodiments, the adhesive gasket 130 fills about 80%, 81%, 82%, 83%, 84%, 85%, 86%, 87%, 88%, 89%, 90%, 91%, 92%, 93%, 94%, 95%, 96%, 97%, 98%, 99%, or 100% of the volume of the pocket 118 and/or ports 126. In some embodiments, minimal (e.g., less than 10% of the volume of the pocket 118) voids are present in the adhesive gasket 130 and/or in the pocket 118 when the adhesive gasket 130 is present in the pocket 118.

The adhesive introduced into a port 126 and/or added into the pocket 118 may have a volume of about 30 mL to 20,000 mL. In some embodiments, the volume of the adhesive introduced into a port 126 and/or present in the pocket 118 is about 30, 40, 50, 60, 70, 80, 90, 100, 150, 200, 250, 300, 350, 400, 450, 500, 550, 600, 650, 700, 750, 800, 850, 900, 950, or 1,000 mL or about 2, 3, 4, 5, 6, 7, 8, 9, 10, 11, 12, 13, 14, 15, 16, 17, 18, 19, or 20 L.

In some embodiments, the adhesive gasket 130 can prevent the separation and/or fracturing of the pipes 110, 120 such as, e.g., during use, prevent fluid (e.g., water) from leaking out of the pipe connection and/or adhesive gasket 130, and/or restrain the connected pipes 110, 120.

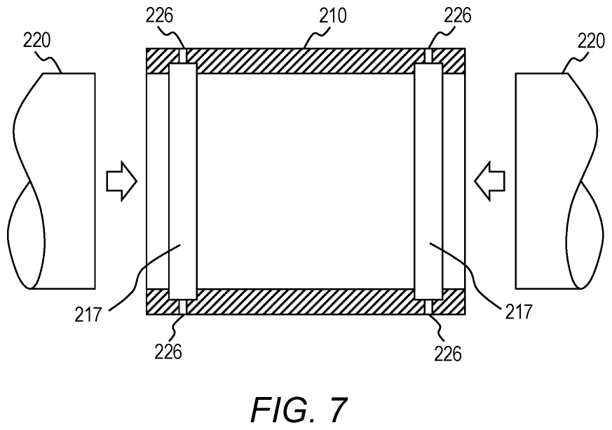

FIG. 7 illustrates an alternative assembly in which two second pipes 220 are inserted into a coupling 210 that serves as the first pipe discussed above. The coupling 210 includes a recess 217 adjacent each end. Each recess 217 is fed by one or more ports 226 that can receive adhesive. Thus, similar to the manner discussed above, one end of each of the second pipes 220 is inserted into the coupling 210, and adhesive is introduced into the recesses 217 via one or more ports 226 and allowed to cure into a gasket.

The adhesive employed in the method described above should be one that (a) is compatible with the pipe (e.g., PVC pipe) and (b) forms an additional structure/component that functions as a gasket that provides a seal. In selecting such an adhesive, in some embodiments, the joined pipes pass the test requirements for the pipe itself. For example, in some embodiments, an adhesive gasket of the present invention has a strength sufficient to meet the requirements for the pipe itself for which the adhesive gasket is used. The test procedures and/or requirements can be found, for example, in ASTM D 3139, AWWA C900-16, AWWA C909-16, EN-ISO 1452 and/or CRT 445-2014. AWWA C900-16 includes both quick-burst and long term pressure tests as described below. Further, in the technique described above, the uncured adhesive may be sufficiently viscous such that it does not simply flow out of the port 126-2 at the bottom of the pipe joint without filling the pocket 118. The adhesive may have a viscosity in a range of about 10,000 centipoise to about 1,000,000 centipoise. In some embodiments, the adhesive employed in a method of the present invention has pseudo-plastic and/or thixotropic properties. In some embodiments, the adhesive thins during the shearing action of delivery and/or thickens in place without further shearing.

The adhesive employed in a method of the present invention may be a two-part adhesive. Two-part adhesives are characterized by the fact that they cure not because a substance such as a solvent or water evaporates, but because of a chemical reaction. In contrast, a solvent cement (e.g., a PVC solvent cement) includes a solvent and adhesion is based on the swelling, dissolution and diffusion characteristics of the solvents. For a solvent cement, the solvents diffuse into the base material, cause it to swell, and assisted by the dissolved incorporated polymer fraction, lead to bonding of the components when the pipe is inserted into the fitting. A PVC solvent cement is based on PVC dissolved in solvents such as tetrahydrofuran (THF), cyclohexanone and ketones. Past attempts to use PVC solvent cements to bond bell and spigot in municipal water projects have been unsuccessful due to the large pipe diameter used in municipal water distribution. As pipe diameter increases, so does the difficulty in installation. Large diameter fittings often have short sockets and it is important that the spigot bottoms out into the fitting. Large diameter pipe is heavy and can develop significant resistance during insertion before reaching the end of the fitting. For this reason, the use of a “come-along” or similar device may be required or recommended. Typically, the time it takes to apply the solvent cements for bonding pipe far exceeds the time to insert a pipe into the bell end of a pipe with a gasket to seal the connection. As an additional obstacle, large diameter pipe and fittings also typically require longer set and cure times. As such, solvent cement is not a suitable technique for bonding large diameter PVC pipes, particularly if they require a gasket.

A two-part adhesive of the present invention may comprise an initiator part and an activator part. In some embodiments, the initiator part and/or activator part are solvent-free. In some embodiments, the adhesive is solvent-free. Two-part adhesives can rely on three main systems: (1) epoxy resins prepared by mixing multifunctional epoxy resins with multifunctional amines, (2) polyurethane-forming systems prepared from multifunctional isocyanates and polyols, and (3) acrylic based chemistry. In some embodiments, an adhesive of the present invention is a methyl methacrylate based adhesive.

In some embodiments, an adhesive of the present invention is an acrylic adhesive composition that optionally is heat and/or moisture resistant. Example acrylic adhesive compositions that may be used in a method of the present invention include, but are not limited to, those described in U.S. Pat. No. 9,676,922, the contents of which are incorporated herein by reference in their entirety.

An adhesive of the present invention may comprise an initiator part and an activator part that are kept separated prior to use. The initiator part comprises at least one polymer dissolved in a (meth)acrylate monomer and a free radical initiator. The activator part comprises at least one polymer dissolved in a (meth)acrylate monomer and a reducing agent. In some embodiments, the activator part may comprise a pyridinic reducing agent, an organometallic curing promoter and/or a thiourea accelerator. The initiator part may include a co-initiator. The activator part may include a crosslinker.

In both the initiator part and the activator part at least one polymer is dissolved in a (meth)acrylate monomer. The initiator part and activator part may comprise the same (meth)acrylate monomer or different (meth)acrylate monomer(s). Suitable (meth)acrylate monomers include, but are not limited to, C₁ to C₂₀ alkyl esters of methacrylic acid. Exemplary (meth)acrylate monomers include, but are not limited to, methyl (meth)acrylate, ethyl (meth)acrylate, propyl (meth)acrylate, isopropyl (meth)acrylate, isobutyl (meth)acrylate, sec-butyl (meth)acrylate, t-butyl (meth)acrylate, tetrahydrofurfuryl (meth)acrylate, 2-ethyl hexyl (meth)acrylate, hydroxyethyl (meth)acrylate, dicyclopentadienyl (meth)acrylate, isobornyl (meth)acrylate, and mixtures and blends thereof. In some embodiments, the (meth)acrylate monomer may be a C₁ to C₄ alkyl ester of methacrylic acid. In some embodiments, the (meth)acrylate monomer may be methyl methacrylate. An initiator part and an activator part may each comprise a (meth)acrylate monomer in an amount of about 40%, 45%, or 50% to 55%, 60%, or 65% by weight of the part (e.g., initiator part or activator part).

Suitable polymers for the initiator part and/or activator part include, but are not limited to, homopolymers such as poly(methyl methacrylate) (PMMA), polystyrene (PS), polydicyclopentadiene (PDCPD), copolymers such as poly(methacrylate-acrylonitrile-butadiene-styrene) (MABS), poly(acrylate-styrene-acrylonitrile) (ASA), poly(acrylonitrile-butadiene-styrene) (ABS), and block copolymers of butadiene or isoprene with styrene, acrylonitrile such as styrene-butadiene-styrene (SBS), styrene-isoprene-styrene (SIS), and mixtures and blends thereof. In some embodiments, the initiator part and/or activator part comprises poly(acrylonitrile-butadiene-styrene) (ABS). An initiator part and an activator part may each comprise a polymer (e.g., ABS) in an amount of about 10%, 15%, or 20% to 25%, 30%, or 35% by weight of the part (e.g., initiator part or activator part).

A core-shell graft copolymer can optionally be present in an adhesive composition of the present invention, which may modify the flow properties of the uncured adhesive composition and/or improve the fracture toughness of the cured adhesive composition. The core-shell graft copolymers have a rubbery core made from polymers of “soft” or “elastomeric” monomers such as butadiene or ethyl acrylate, and a hard shell made from “hard” monomers such as methyl methacrylate, styrene or acrylonitrile. A common core-shell graft copolymer is a MBS polymer which is made by polymerizing methyl methacrylate in the present of poly(butadiene-styrene) copolymer rubber. A core-shell graft polymer in an adhesive of the present invention may swell but do not dissolve therein. Additionally useful core-shell graft copolymers are described in U.S. Pat. Nos. 3,984,497; 4,034,013; 4,096,202; 4,306,040; and 5,112,691. Other impact modifiers and/or toughening agents may be added to the adhesive composition. An initiator part and an activator part may each comprise a core-shell graft copolymer in an amount of about 1% or 5% to 10% by weight of the part (e.g., initiator part or activator part).

Suitable free radical initiators that may be present in an adhesive of the present invention include, but are not limited to, organic peroxides, organic hydroperoxides, peresters and peracids. The initiator (or a catalyst as they are sometimes referred) may be used to initiate or start polymerization. Exemplary free radical initiators include, but are not limited to, benzoyl peroxide, cumene hydroperoxide, tertiary butyl hydroperoxide, dicumyl peroxide, tertiary butyl peroxyacetate, tertiary butyl perbenzoate, and mixtures thereof. In some embodiments, an adhesive of the present invention comprises a free radical initiator in an amount of up to about 10 percent by weight of the adhesive and, in some embodiments, about 0.05 to 3 percent by weight of the adhesive.

The initiator part and/or the activator part may include an inhibitor or stabilizer to prevent premature polymerization and/or to provide a desirable working time of the adhesive. The common inhibitors or stabilizers include, but are not limited to, phenols such as butylated hydroxyl toluene (BHT), 2,6-di-tert-butyl-4-(dimethylaminomethyl)phenol, quinones (benzoquinone), hydroquinones (hydroquinone monomethyl ether, MEHQ, trimethylhydroquinone), 2-(2-Hydroxy-5-methylphenyl)benzotriazole, 2,6-di-tert-butyl-4-(dimethylaminomethyl)phenol, and the like. In some embodiments, an adhesive of the present invention comprises an initiator or stabilizer in an amount of up to about 5 percent by weight of the adhesive and, in some embodiments, about 0.01 to about 2 percent by weight of the adhesive.

One or more organic acids such as, e.g., carboxylic acids, may be present in an adhesive of the present invention and may accelerate cure time and/or enhance adhesion of the adhesive to the substrates or components. The carboxylic acids (e.g., unsaturated and/or polymerizable carboxylic acids) may be present in an adhesive in an amount of up to about 20 percent by weight of the adhesive and, in some embodiments, up to about 10 percent by weight of the adhesive. Exemplary carboxylic acids include, but are not limited to, methacrylic acid, maleic acid, acrylic acid, crotonic acid, fumaric acid, malonic acid, acetylene dicarboxylic acid, dibromo maleic citranoic acid, mesaconic acid, and oxalic acid. By adding one or more carboxylic acids, particularly strong organic carboxylic acids, to an adhesive composition, the bonding characteristics of the adhesive composition to the subsequently bonded structural components and parts may be improved.

A reducing agent may be present in the activator part of an adhesive to co-react with the free radical initiator. A reducing agent may be present in an adhesive in an amount up to about 15 percent by weight of the adhesive and, in some embodiments, about 0.01 to about 5 percent by weight of the adhesive. Exemplary reducing agents include, but are not limited to, tertiary amines and aldehyde amine reaction products. Suitable tertiary amines may include, but are not limited to, N,N-dimethyl aniline, N,N-diethyl toluidine, N,N-bis(2-hydroxy ethyl) toluidine and the like. In some embodiments, the reducing agent may be a pyridinic compound such as, e.g., aldehyde-amine reaction products including such compositions as butyraldehyde-aniline and butyraldehyde-butylamine derivatives whose active ingredient is a dihydropyridine (DHP) formed from condensation of three moles of aldehyde with one mole of amine. In some embodiments, a DHP-enriched version of these compositions may be used. One such material is Reillycat ASY-2, available from Reilly Industries, Inc., and is 3,5-diethyl-1-phenyl-2-propyl-1,2 dihydropyridine (PDHP). This reducing system is often used in combination with a co-initiator sulfonyl chloride.

A co-initiator may be present in an initiator part of an adhesive of the present invention. Example co-initiators include, but are not limited to, organic sulfonyl chlorides and chlorosulfonated polymers. Example sulfonyl chlorides include, but are not limited to, C₁-C₁₂, alkyl sulfonyl chlorides, C₆-C₂₄ aromatic sulfonyl chlorides, such as, e.g., 4-toluenesulfonyl chloride. In some embodiments, an adhesive composition of the present invention comprises a chlorosulfonated polymer such as, e.g., chlorosulfonated polyethylene. Additional example sulfonyl chlorides and chlorosulfonated polymers include those described in U.S. Pat. No. 4,182,644, which is incorporated herein by reference. In some embodiments, a co-initiator is present in an initiator part in an amount of about 0.1% or 0.5% to 2% or 5% by weight of the initiator part.

Suitable thioureas include, but are not limited to, monosubstituted thiourea compounds with a heteroatom, i.e., oxygen, nitrogen or sulfur, in a position beta to the nitrogen of the thiourea bearing the substituent, or a monosubstituted thiourea comprising an ether oxygen atom in a position gamma to the substituted nitrogen of the thiourea, such as described in U.S. Pat. Nos. 3,991,008 and 4,569,976. Additionally useful thioureas and derivatives are described in U.S. Patent Application Publication No. 2007/0040151. Exemplary thioureas include ethylene thiourea, 1-acetyl-2-thiourea, 1-(2-pyridyl)-2-thiourea. The thiourea may be present in an adhesive composition of the present invention in an amount of up to about 5 percent by weight of the adhesive composition, and, in some embodiments, about 0.01 to about 2 percent by weight of the activator part.

In some embodiments, a multifunctional monomer and/or oligomer including, e.g., those derived from epoxy and polyurethane backbones may be utilized as a crosslinker in an adhesive of the present invention and may enhance the performance of the adhesive such as, e.g., heat resistance of the adhesive. Crosslinking monomers include multifunctional (meth)acrylate monomers, such as, but not limited to, di- or tri-functional (meth)acrylates like hexanediol di(meth)acrylate, trimethylol propane tri(meth)acrylate (TMPTMA), polyethylene glycol di(meth)acrylates, ethylene glycol dimethacrylate (EGDMA), diethylene glycol dimethacrylate, triethylene glycol dimethacrylate (TEGDMA), tetraethylene glycol di(meth)acrylate, dipropylene glycol dimethacrylate, di-(pentamethylene glycol) dimethacrylate, digylcerol tetramethacrylate, tetramethylene dimethacrylate, ethylene dimethacrylate, neopentyl glycol diacrylate, trimethylol propane triacrylate and bisphenol-A di(meth)acrylates, such as ethoxylated bisphenol-A di(meth)acrylate (EBPADMA), bisphenol-F di(meth)acrylates, such as ethoxylated bisphenol-F di(meth)acrylate, and urethane dimethacrylate (UDMA). The crosslinking monomer component may be present in an adhesive in an amount from about 0.01 to about 20 percent by weight of the adhesive.

Suitable organo-metallic curing promoters include, but are not limited to, organic salts of a transition metal, such as cobalt, nickel, manganese or iron naphthenate, cobalt neodecanoate, cobalt stearate, copper octoate, copper acetylacetonate, iron hexoate, or iron propionate. Promoters may be used to enhance cure rate. Promoters may be present in an adhesive in an amount of up to about 2 percent by weight of the activator part and, in some embodiments, about 1 part per million to about 0.5 percent by weight of the activator part.

Suitable additives to the initiator part and/or the activator part include, but are not limited to, viscosity control agents, fillers, plasticizers, fragrances, pigments and so on. Viscosity control agents may include, but are not limited to, organoclays, fumed silica or the like and may be present in an adhesive in an amount ranging from about 0.1 to about 10 percent by weight of the adhesive.

In some embodiments, a filler may be added in a large amount to reduce the cost of the adhesive and/or to modify certain physical properties such as, e.g., shrinkage and/or exotherm characteristics. In this case, quantity of the filler or extender may be considered separately as an additive to the base polymer and monomer composition as described above. Common particulate fillers or extenders such as, e.g., clay, talc, calcium carbonate, calcium sulfate, silica, alumina trihydrate, bentonite, glass beads, etc. may be present in an adhesive in an amount of up to about 50 percent by weight of the adhesive and may be used to achieve specific economic, application and/or bonding characteristics.

In some embodiments, an adhesive of the present invention is pseudo-plastic and/or thixotropic, i.e., shear thinning in rheology, a non-Newtonian behavior of fluids whose viscosity decreases under shear strain. The adhesive may have a viscosity in a range of about 10,000 centipoise to about 1,000,000 centipoise. In some embodiments, the kinetic viscosity of the adhesive may be very low, such as, e.g., not more than about 5,000 cps; thus, allowing for the adhesive to readily flow through the pocket 118 around the pipe. In some embodiments, the stationary viscosity of the adhesive is very high, such as, e.g., at least about 500,000 cps. The higher stationary viscosity may allow the adhesive, upon being deposited on the surface, to stay in place and not flow away from where deposited after injection. To achieve a non-Newtonian behavior of fluids, pseudoplastic rheology additives may be present in an adhesive of the present invention. Example thixotropic rheology additives include, but are not limited to, inorganic thickeners, organic polymers, and mixtures thereof. Example inorganic thickeners that may be present in an adhesive of the present invention include, but are not limited to, surface-treated fumed silicas and clays (synthetic or natural). A surface-treated fumed silica may be produced by the treatment of hydrophilic fumed silica with silanes such as, e.g., hexa-methyldisilazane (HMDZ), alkyl-chlorosilanes, and oligomers or polymers such as polydimethylsiloxane (PDMS). In a process for preparing a surface-treated fumed silica, some or most of the silanol groups on the surface may be replaced with organosilicon groups, changing the high-surface-energy, hydrophilic surface to a surface with low surface energy and hydrophobic nature. In some embodiments, an adhesive including a surface-treated fumed silica may exhibit shear thinning behavior. Commercially available treated fumed silicas include, but are not limited to, CAB-O-SIL® TS-720, TS-530, TS-610, Aerosil® R972, R974, R202, R208, R805, R812, R7200, R8200, R9200, HDK® H2000. Organic polymer thickeners include, but are not limited to, polymers or copolymers such as ABS copolymer. A thixotropic rheology additive may be present in an adhesive of the present invention in an amount of up to about 50 percent by weight of the adhesive such as, e.g., about 1% to 5%, 10%, 20%, or 30% by weight of the adhesive.

An adhesive of the present invention may also include an expandable filler. An expandable filler may improve filling of the pocket 118 with the adhesive gasket 130, reduce or eliminate the presence of voids such as, e.g., those due to the polymerization shrinkage in the adhesive gasket 130 and/or pocket 118 when the adhesive gasket 130 is present, and/or enhance sealing of the adhesive gasket 130. Polymerization shrinkage of the adhesive can pose problems for joining the pipes. The formation of large voids of the cured adhesive pulling away from the pipe walls can occur if the polymerization shrinkage is severe. This can cause poor sealing and leakage. In some embodiments, one or more expandable fillers may be present in an adhesive and may cause the adhesive volume to expand, and may thereby effectively offset polymerization shrinkage as the adhesive cures. Exemplary expandable fillers include, but are not limited to, rubber balls and/or thermoplastic microspheres or nanospheres. In some embodiments, an adhesive comprises an expandable filler and the expandable filler is thermally expandable microspheres.

Thermally expandable microspheres may be made of a thermoplastic polymer or copolymer such as, e.g., an acrylonitrile-based copolymer shell encapsulating a low boiling point thermal expansion agent such as, e.g., isobutane within the shell. The thermoplastic polymer shell may soften upon heating by exothermic reaction of the adhesive. The volume of the polymer shell may increase as the volume of the thermal expansion agent increases, thus increasing the volume of the adhesive. In some embodiments, the expansion initiation temperature of the thermally expandable microspheres is lower than the maximum exothermic reaction temperature of the adhesive. The expansion initiation temperature may be about 70° C. or more, about 80° C. or more, or about 100° C. or more. The thermally expandable microspheres may be of any size. The average unexpanded size of the thermally expandable microspheres may be about 5 μm to about 40 μm. Example unexpanded sizes include, but are not limited to, about 5 μm, about 10 μm, about 15 μm, about 20 μm, about 25 um, about 30 um, about 35 μm, or about 40 μm. An example of a thermally expandable microsphere is Expancel 031 DU 40 commercially available from Akzo Nobel, 2240 Northmont Parkway, Duluth, Ga. 30096. An expandable filler may be present in an adhesive in an amount of about 20 percent or more by weight of the adhesive.

In some embodiments, an adhesive of the present invention may expand during curing by means of a chemical reaction when the two parts are mixed and the ensuing reaction releases gases. An example that demonstrates this behavior is the reaction of isocyanates with water during the formation of polyurethane foams.

In use, each part of an adhesive may be formed or compounded and stored separately in inventory by the adhesive manufacturer, a distributor or end user or any combination thereof. Prior to introducing an adhesive into a port 126, the initiator part and the activator part are mixed together using conventional mixers such as a static mixer known to those skilled in the art. The mixing ratio of an initiator part to an activator part can be anywhere from about 1:1 to about 1:100. In commercial and industrial environments, a volume ratio is commonly used for convenience. Some common mixing ratios are 1:1, 1:2, 1:4 and 1:10, but preferably 1:10, more preferably 1:4 and most preferably 1:1. In some embodiments, the initiator part and activator part are supplied in an amount to achieve the desired mixing ratio. In some embodiments, the initiator part and the activator part are homogeneously mixed. Application to pipes 110, 120 may be accomplished using conventional means such as, e.g., a dauber, brush, rag, towel, and/or the like, and/or by injection into a port 126 such as, e.g., with a syringe, funnel, etc. Application may also be to at least one mating surface of the joint before or after assembling the pipe joint.

The reactivity time for an adhesive of the present invention may be about 5 to 60 minutes, about 15 to 45 minutes, about 25 to 35 minutes. “Reactivity time” as used herein refers to the time to reach the maximum temperature of an exothermic reaction from start of combination (e.g., mixing) of a certain amount of an adhesive composition. An adhesive of the present invention may have a set time of less than about 12 hours (e.g., less than about 12, 10, 8, 6, 4, 2, or 1 hour). An adhesive of the present invention may have a cure time of about 2 to 40 hours, about 5 to 36 hours, about 12 to 32 hours, or about 20 to 28 hours.

In some embodiments, an adhesive of the present invention may have a peak exothermic temperature in a range of about 70° C. to 140° C., such as, for example, about 70° C. to 85° C., about 75° C. to 80° C., about 95° C. to 110° C., about 110° C. to 130° C. In some embodiments, an adhesive of the present invention has a peak exothermic temperature of less than about 110° C. or less than about 100° C. The peak exothermic temperature may be measured immediately when a certain amount (e.g., a total of three grams) of an adhesive is combined. For example, in some embodiments, the peak exothermic temperature may be determined by measuring the temperature starting at the time when an initiator part and activator part of an adhesive of the present invention are combined (e.g., mixed).

In some embodiments, an adhesive of the present invention may have a volume expansion capacity from about −20% to 20%, about −10% to 10%, about −5% to 5%, about −1% to 1%. In some embodiments, the volume expansion of a desirable adhesive is close to 0%. The volume expansion ratio can be determined by a buoyancy method known to those skilled in the art. This well-established test method can be used to measure volumetric dimensional changes by measuring density variations before and after the adhesive cures.

Example formulations that may be suitable for use as the adhesive are set forth in the Table 1 below with the weight percentage provided for each component.

TABLE 1
Example adhesives in which a 1:1 ratio of the initiator part and the activator part are utilized.

| | Formula | Formula | Formula | Formula | Formula | Formula |
|---|---|---|---|---|---|---|
| Component | #1 | #2 | # 3 | #4 | #5 | # 6 |

PART A INITIATOR

| | | | | | | |
|---|---|---|---|---|---|---|
| Resin - Acrylonitrile | 22 | 22 | 22 | 22 | 22 | 22 |
| butadiene styrene | | | | | | |
| (ABS) Copolymer | | | | | | |
| Monomer - Methyl | 53.5 | 53.5 | 53.5 | 53.5 | 53.5 | 53.5 |
| Methacrylate (MMA) | | | | | | |
| Monomer - Methacrylic | 7 | 7 | 7 | 7 | 7 | 7 |
| Acid | | | | | | |
| Initiator - Cumene | 2 | 2 | 2 | 2 | 2 | 2 |
| Hydroperoxide | | | | | | |
| Co-initiator - 4- | 1 | 1 | 1 | 1 | 1 | 1 |
| Toluenesulfonyl | | | | | | |
| Chloride(98-59-9) | | | | | | |
| Stabilizer - Butylated | 1.5 | 1.5 | 1.5 | 1.5 | 1.5 | 1.5 |
| Hydroxytoluene | | | | | | |
| Filler - Calcium Sulfate | 3 | 3 | — | — | — | 3 |
| Alumina Trihydrate | 10 | 10 | 12 | 11 | 10 | 10 |
| Expandable Filler | — | 0 | 1 | 2 | 3 | — |
| (Expancel 031 DU 40) | | | | | | |
| PART A TOTAL | 100 | 100 | 100 | 100 | 100 | 100 |

PART B ACTIVATOR

| | | | | | | |
|---|---|---|---|---|---|---|
| Resin - Acrylonitrile | 21 | 22 | 21 | 21 | 21 | 20 |
| butadiene styrene | | | | | | |
| (ABS) copolymer | | | | | | |
| (9003-56-9) | | | | | | |
| Impact Modifier - Core- | | | | | | 2.4 |
| Shell MBS Polymer | | | | | | |
| Monomer - Methyl | 54.85 | 56.6 | 58.6 | 58.6 | 57.6 | 56.45 |
| Methacrylate | | | | | | |
| Monomer - Aliphatic | 6 | 6 | 6 | 6 | 6 | 3 |
| Urethane Acrylate | | | | | | |
| Crosslinker - | — | — | — | — | — | 7 |
| Methacrylate- | | | | | | |
| Terminated | | | | | | |
| Polybutadiene | | | | | | |
| Crosslinker - | 3 | — | — | — | — | — |
| Trimethylolpropane | | | | | | |
| Trimethacrylate | | | | | | |
| Stabilizer - 2,6-Di-tert- | 0.1 | 0.1 | 0.1 | 0.1 | 0.1 | 0.1 |
| butyl-4- | | | | | | |
| (dimethylaminomethyl) | | | | | | |
| phenol | | | | | | |
| Stabilizer - 2-(2- | — | 0.25 | 0.25 | 0.25 | 0.25 | — |
| Hydroxy-5- | | | | | | |
| methylphenyl)benzotri- | | | | | | |
| azole | | | | | | |
| Reducing agent PDHP | 1 | 1 | 1 | 1 | 1 | 1 |
| (Reillycat ASY-2) | | | | | | |
| Promoter - Copper(II) | 0.00025 | 0.00025 | 0.00025 | 0.00025 | 0.00025 | 0.00025 |
| Acetylacetonate | | | | | | |
| Accelerator - Ethylene | 0.05 | 0.05 | 0.05 | 0.05 | 0.05 | 0.05 |
| Thiourea | | | | | | |
| Thickener - Treated | 1 | 1 | 1 | 1 | 1 | — |
| Fumed Silica | | | | | | |
| Filler - Calcium Sulfate | 3 | 3 | — | — | — | — |
| Filler - Alumina | 10 | 10 | 11 | 10 | 10 | 10 |
| Trihydrate | | | | | | |
| Expandable Filler | — | 0 | 1 | 2 | 3 | — |
| (Expancel 031 DU 40) | | | | | | |
| PART B TOTAL | 100 | 100 | 100 | 100 | 100 | 100 |
| Reactivity Time | 19′26″ | 29′46″ | 25′18″ | 22′7″ | 22′14″ | 27′33″ |
| Maximum Exothermic | 98.2 | 78.2 | 95.1 | 94.5 | 103.6 | 83.4 |
| Temperature (° C.)/3 g | | | | | | |
| Viscosity (Average of | 820,000 | 815,000 | 750,000 | 845,000 | 800,00 | — |
| A and B) (cps)* | | | | | | |
| Volume Expansion | | −20.95 | 0.64 | 6.87 | 8.80 | |
| @24 h (%) | | | | | | |

*Viscosity is measured with Brookfield LVT Viscometer, Spindle #4 at 0.6 rpm.

Embodiments of the invention are described in the following non-limiting examples.

### EXAMPLES

### Preparation of Test Samples in the Examples

A Vinyl Tech 4-inch DR-18 C900 PVC pipe meeting the requirements of AWWA C900-16 was cut into 12 inch segments and beveled at a 15° angle. The bell end of the pipe or coupling including two bulges or two machined grooves were used to prepare the assemblies for the pressure tests. Any pre-installed gaskets were removed. The pipe and the couplings were wiped with a dry cloth to remove any dust. In some examples the pipe and couplings were cleaned with Weld-On C-65 pipe cleaner in the areas that are exposed to the adhesive. After removal of the rubber gasket, two holes were created on the pocket that originally held the gasket by drilling at opposing sides of each bulge/ridge in the coupling.

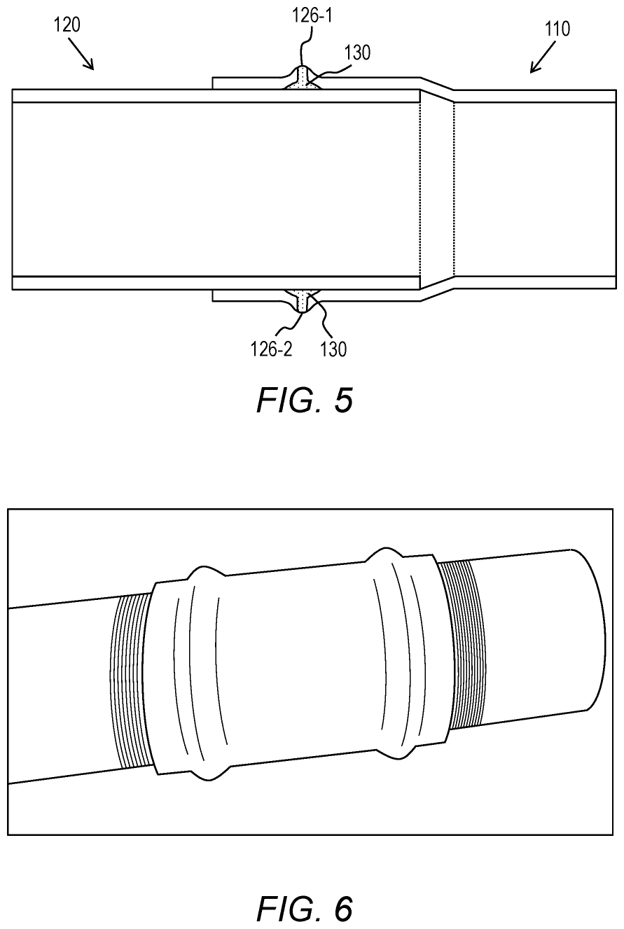

Each of the pipe ends were inserted into the wider opening of a coupling or the bell end of the pipe to a depth of 4-6 inches as shown in FIG. 6. The adhesive was injected into one of the holes of the first bulge until the adhesive flowed out of the hole on the opposing side, and this process was repeated at the second bulge. The same process was performed when a coupling was used as shown in FIG. 7, but the adhesive was injected into a hole providing access to the groove or recess in the coupling. After the injection, the joint was cured for 24 hours before hydrostatic pressure tests were conducted. During the test, a hydrostatic pressure was applied from a Digital Pipe Tester Airless Blueline Model 1675 (IPT Institute fur Prueftechnik Geraetebau GmbH & Co. KG, Germany). Any leakage, rupture or separation at the pipe joint under test causing loss of pressure shall constitute failure.

### Pressure Testing for the Examples

Long term pressure (sustained pressure) and quick-burst pressure tests were conducted on the samples at room temperature (23±2° C.) according to the specifications of AWWA C900-16. The testing requirements are shown in Table 2 below.

TABLE 2
Testing requirements for 4 inch PVC Pipe per AWWA C900-16

| | | Sustained-Test | Quick Burst- |
|---|---|---|---|
| | Pressure | Pressure | Test Pressure |
| DR | Class | (1000 hours) | (60-70 seconds) |
| 25 | 165 psi | 350 psi | 535 psi |
| 18 | 235 psi | 500 psi | 755 psi |
| 14 | 305 psi | 610 psi | 985 psi |

### Example 1

GPK 4-inch DR 18 repair couplings including two bulges for C-900 PVC pipe were used for Example 1. The pipe and the coupling were cleaned with Weld-On C-65 pipe cleaner. An amount of 100-120 grams of adhesive was injected into one of the holes of the first bulge and the adhesive flowed out of an opposing hole of the bulge. The same process was repeated at the second bulge of the coupling.

Table 3 and Table 4 provide the results for the pressure tests for samples prepared in Example 1 using formulations provided in Table 1 as well as Weld-On #45. Weld-On #45 is a commercially available two component methyl methacrylate based reactive adhesive. It is supplied in a cartridge in a 4:1 mix ratio. The “1” part of the cartridge contains among other ingredients benzoyl peroxide and plasticizer as suspension agent for the peroxide. The initiator chemistry of this commercial product differs from the formulations presented in Table 1.

TABLE 3
Results of quick-burst pressure tests

| | Quick-burst Pressure | |
|---|---|---|
| | (psi) with | Failure |
| Adhesive | 4 inch GPK coupling | Mode |
| Gasket Only | 810 | Ruptured |
| Weld-On #45 | 520 | Ruptured |
| Formula #2 | 794 | Ruptured |
| Formula #3 | 750 | Ruptured |
| Formula #4 | 735 | Ruptured |
| Formula #5 | 659 | Ruptured |
| Formula #6 | 675 | Ruptured |

TABLE 4
Results of long term pressure tests

| | Test Time at Sustained | |
|---|---|---|
| | Pressure (hr) with | |
| Adhesive | 4 inch GPK coupling | Failure Mode |
| Formula #1 | 70 (@350 psi) | Fitting rupture |
| Formula #2 | 1350 (@350 psi) | No Failure |
| | 1000 (@500 psi) | No Failure |
| Formula #3 | 961 (@500 psi) | Crack at coupling |

### Example 2

4-inch Fluid-Tite couplings with a DR 14 pressure rating with two rectangular recesses or grooves on the inner surface of C-900 PVC pipe were used for Example 2. The pipe and the coupling were cleaned with Weld-On C-65 pipe cleaner except as otherwise noted. About 50-70 grams of adhesive was injected into one of the holes drilled where the groove is located and the adhesive flowed out of the hole on the opposing side. The same process was repeated at the second side of the coupling.

Table 5 provides the results for the pressure tests discussed for the samples prepared in Example 2 using formulations provided in Table 1.

TABLE 5
Results of quick-burst pressure with Fluid-Tite couplings

| | Quick-burst | |
|---|---|---|
| | Pressure (psi) with | |
| | 4 inch Fluid-Tite | |
| Adhesive | coupling | Failure Mode |
| Gasket Only | 930 | Pipe expanded, deformation of |
| Dry wipe | | steelbars led to leak at cap |
| only | | |
| Formula #1 | 1042 | Assembly bursted, origin of |
| | | burst cannot be identified |
| Formula #2 | 1009 | Pipe burst |
| Formula #3 | 1131 | Assembly bursted, origin of |
| | | burst cannot be identified |
| Formula #4 | 997 | Pipe expanded and a crack |
| | | opened in pipe |
| Formula #4 | 921 | Pipe expanded and a crack |
| Dry wipe | | opened in pipe |
| only | | |
| Formula #5 | 998 | Pipe burst |
| Formula #6 | 1001 | Pipe burst |

### Example 3

The bell end of a C-900 PVC with a DR 18/DR 14 pressure rating with a bulge was used for Example 3. The bell end of the pipe as well as the second piece of pipe were cleaned with Weld-On C-65 pipe cleaner. About 100-120 grams of adhesive was injected into one of the holes of the first bulge and the adhesive flowed out of an opposing hole the bulge.

### Results of Pressure Testing

The results of the pressure tests for the sample prepared in Example 3 are shown in the Table 6 below.

TABLE 6
Results of quick-burst pressure test with joint prepared
with bell end of C-900 DR-18/DR-14 pipe.

| | | Quick-burst | |
|---|---|---|---|
| | Pressure | Pressure (psi) with | |
| Adhesive | Rating | bell from pipe | Failure Mode |
| Formula #2 | DR-18 | 796 | Burst on pressure |
| | | | side of bell |
| Formula #2 | DR-14 | 1023 | Burst on pressure |
| | | | side of bell |

Unexpectedly, the results from the above examples show that the adhesives can have the strength and the gap filling capacity to meet or exceed the requirements of AWWA C900-16 for the strength of the pipe itself. Formula #2 met the quick burst requirements of AWWA C900-16 for the pipe itself when tested with a 4-inch DR-18 C900 PVC pipe and the GSK repair coupling. The comparative example Weld-On #45 failed far below the threshold level of 750 PSI. Table 5 shows that using the 4-inch Fluid-Tite coupling all adhesives passed the quick burst requirements of AWWA C900-16 for the pipe itself. The results presented in Table 5 clearly show that the pressure test results improve significantly when a suitable coupling or bell configuration is used. Finally, Example 3 shows that the current bell design, using the bulge that originally held a gasket of the tested C-900 pipe at the bell end, in combination with Formula #2 meets the quick burst pressure requirements of AWWA C 900-16.

A visual inspection of a cross-section of the tested assemblies shows that assemblies prepared with a formulation including an expandable filler show far less voids that could potentially create leak paths. This is especially noticeable at the injection port.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A joined pipe assembly, comprising:
a first pipe having a first end portion with a first outer diameter and a first inner diameter;
a second pipe having a second end portion with a second inner diameter and a second outer diameter, wherein the second end portion nests within the first end portion;
wherein the first end portion includes a circumferential recess, and wherein an inner surface of the recess is located radially outward of the first inner diameter to form a pocket; and
an adhesive gasket positioned in the pocket and adhered to the inner surface of the recess and the second outer diameter.

2. The joined pipe assembly defined in claim 1, wherein the recess includes at least one port into the pocket configured to receive an uncured adhesive that cures into the adhesive gasket, optionally wherein the recess includes a first port configured to receive an uncured adhesive that cures into the adhesive gasket and a second port opposing the first port.

3. The joined pipe assembly defined in claim 2, wherein the at least one port comprises a plurality of ports.

4. The joined pipe assembly defined in claim 3, wherein the plurality of ports is spaced generally circumferentially equidistant around the recess.

5. The joined pipe assembly defined in any one of claims 1-5, wherein the first pipe includes a main portion that merges with the first end portion and the main portion having a third inner diameter that is less than the first inner diameter.

6. The joined pipe assembly defined in claim 5, wherein the third inner diameter is substantially equal to the second inner diameter.

7. The joined pipe assembly defined in any one of claims 1-6, wherein the adhesive gasket comprises a cured two-part adhesive.

8. The joined pipe assembly defined in claim 7, wherein the cured two-part adhesive comprises a methyl methacrylate adhesive.

9. The joined pipe assembly defined in claim 8, wherein the methyl methacrylate adhesive comprises:
an initiator part comprising at least one polymer dissolved in a (meth)acrylate monomer and a free radical initiator; and
an activator part comprising at least one polymer dissolved in a (meth)acrylate monomer and a reducing agent.

10. The joined pipe assembly defined in claim 9, wherein the initiator part and/or the activator part further comprises an expandable filler.

11. The joined pipe assembly defined in any one of claims 1-10, wherein the first and/or second pipe comprise polyvinylchloride (PVC).

12. The joined pipe assembly defined in any one of claims 1-11, wherein the adhesive gasket defines a continuous annulus.

13. The joined pipe assembly defined in any one of claims 1-12, wherein the pocket is generally triangular in cross-section.

14. The joined pipe assembly defined in any one of claims 1-13, wherein the joined pipe assembly is buried in soil, optionally without a mechanical restraint.

15. The joined pipe assembly defined in any one of claims 1-14, wherein the second outer diameter is between about 4 and 27 inches.

16. The joined pipe assembly defined in any one of claims 1-15, wherein the recess extends radially outwardly between about 0.3 and 1.5 inches from the first outer diameter.

17. The joined pipe assembly defined in any one of claims 1-16, wherein the first pipe includes a circumferential ridge and an outer surface of the ridge extends radially outwardly from the first outer diameter, and wherein the recess forms the inner surface of the ridge.

18. The joined pipe assembly defined in any one of claims 1-17, wherein the joined pipe assembly meets or exceeds the sustained pressure test and/or quick-burst pressure test requirements, as specified in AWWA C900-16.

19. A method of joining two pipes, comprising the steps of:
(a) providing a first pipe, the first pipe having a first end portion with a first outer diameter and a first inner diameter, wherein the first end portion includes a circumferential recess, and wherein an inner surface of the recess is located radially outward of the first inner diameter to form a pocket;
(b) providing a second pipe, the second pipe having a second end portion with a second inner diameter and a second outer diameter;
(c) inserting the second end portion within the first end portion; and
(d) introducing an adhesive gasket into the pocket, the adhesive gasket adhering to the inner surface of the recess and the second outer diameter to join the first and second pipes.

20. The method defined in claim 19, wherein the adhesive gasket forms an annular seal between the first inner diameter and the second outer diameter.

21. The method defined in claim 19 or 20, wherein step (d) comprises injecting uncured adhesive into a port in the recess that fluidly communicates with the pocket and curing the uncured adhesive to form the adhesive gasket.

22. The method defined in claim 21, wherein the recess includes a second port, and wherein the injecting step ceases when the uncured adhesive flows out of the second port, optionally wherein the second port opposes the first port.

23. The method defined in any one of claims 19-22, wherein the uncured adhesive comprises a methyl methacrylate adhesive.

24. The method defined in claim 23, wherein the methyl methacrylate adhesive comprises:
an initiator part comprising at least one polymer dissolved in a (meth)acrylate monomer and a free radical initiator; and
an activator part comprising at least one polymer dissolved in a (meth)acrylate monomer and a reducing agent.

25. The method defined in claim 24, wherein the initiator part and/or the activator part further comprises an expandable filler.

26. The method defined in any one of claims 19-25, wherein the first and/or second pipe comprise polyvinylchloride (PVC).

27. The method defined in any one of claims 19-26, further comprising the step of burying the first and second pipes in soil after the introducing step, optionally without a mechanical restraint.

28. The method defined in any one of claims 19-27, wherein the first pipe includes a circumferential ridge and an outer surface of the ridge extends radially outwardly from the first outer diameter, and wherein the recess forms the inner surface of the ridge.

29. The method defined in any one of claims 19-28, wherein the joined pipes meet or exceed the sustained pressure test and/or quick-burst pressure test requirements, as specified in AWWA C900-16.
